(19) United States
(12) Patent Application Publication
(10) Pub. No.: US 2025/0350973 A1
(43) Pub. Date: Nov. 13, 2025

(54) SIGNALING FOR MOBILITY IN CONNECTED MODE

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 19/187,948

(22) Filed: Apr. 23, 2025

Related U.S. Application Data
(60) Provisional application No. 63/644,922, filed on May 9, 2024.
(60) Provisional application No. 63/649,243, filed on May 17, 2024.

(51) Int. Cl. H04W 24/08

(52) U.S. Cl. CPC H04W 24/08

(57) ABSTRACT

Apparatuses and methods that support signaling for mobility in connected mode are provided. A method for a user equipment (UE) includes receiving a signal based on first quasi co-location (QCL) properties for the signal and determining, based on the signal, a round trip time (RTT) value between transmissions to a base station based on a first spatial filter and receptions from the base station based on the first QCL properties. The method further includes determining that the RTT value is greater than a threshold value and transmitting, to the base station, the RTT value.

### CROSS-REFERENCE TO RELATED AND CLAIM OF PRIORITY

The present application claims priority under 35 U.S.C. § 119(e) to U.S. Provisional Patent Application No. 63/644,922 filed on May 9, 2024, and U.S. Provisional Patent Application No. 63/649,243 filed on May 17, 2024, which are hereby incorporated by reference in their entirety.

### TECHNICAL FIELD

The present disclosure relates generally to wireless communication systems and, more specifically, the present disclosure is related to apparatuses and methods to support signaling for mobility in connected mode.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signaling for mobility in connected mode.

In one embodiment, a method for a user equipment (UE) is provided. The method includes receiving a signal based on first quasi co-location (QCL) properties for the signal and determining, based on the signal, a round trip time (RTT) value between transmissions to a base station based on a first spatial filter and receptions from the base station based on the first QCL properties. The method further includes determining that the RTT value is greater than a threshold value and transmitting, to the base station, the RTT value.

In another embodiment, a UE is provided. The UE includes a transceiver configured to receive a signal based on first QCL properties for the signal and a processor operably coupled to the transceiver. The processor is configured to determine, based on the signal, a RTT value between transmissions to a base station based on a first spatial filter and receptions from the base station based on the first QCL properties and determine that the RTT value is greater than a threshold value. The transceiver is further configured to transmit, to the base station, the RTT value.

In yet another embodiment, a base station is provided. The base station includes a transceiver. The transceiver is configured to transmit a signal based on first QCL properties for the signal to a UE, receive, from the UE, a RTT value between receptions by the base station based on a first spatial filter and transmissions from the base station based on the first QCL properties, and transmit, to the UE, an indication to stop receptions based on the first QCL properties and start receptions based on second QCL properties.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure according to embodiments of the present disclosure;

FIG. 8 illustrates an example encoding structure for physical downlink control channel (PDCCH) in a subframe according to embodiments of the present disclosure;

FIG. 9 illustrates an example decoding structure for PDCCH in a subframe according to embodiments of the present disclosure;

FIG. 10 illustrates an example system for cell coverage according to embodiments of the present disclosure;

FIG. 11 illustrates a flowchart of an example procedure for conditional handover (CHO) according to embodiments of the present disclosure;

FIG. 12 illustrates an example system for cell coverage according to embodiments of the present disclosure;

FIG. 13 illustrates a flowchart of an example UE procedure for reporting a measured UE-gNB RTT value and a reception of a new beam indication according to embodiments of the present disclosure; and

FIG. 14 illustrates a flowchart of an example procedure for beam failure request (BFR) according to embodiments of the present disclosure.

### DETAILED DESCRIPTION

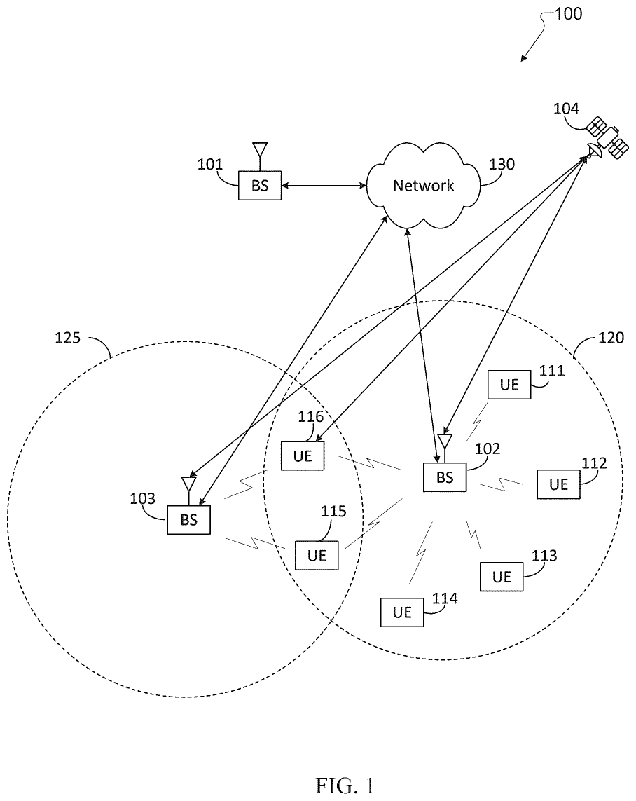

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0 and v18.2.0, “NR; Physical channels and modulation;” [REF 2] 3GPP TS 38.212 v18.2.0, “NR; Multiplexing and channel coding;” [REF 3] 3GPP TS 38.213 v18.1.0 and v18.2.0, “NR; Physical layer procedures for control;” [REF 4] 3GPP TS 38.214 v18.2.0, “NR; Physical layer procedures for data;” [REF 5] 3GPP TS 38.321 v18.1.0, “NR; Medium Access Control (MAC) Protocol Specification;” and [REF 6] 3GPP TS 38.331 v18.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof to support signaling for mobility in connected mode. In certain embodiments, one or more of the BSs 101-103 include circuitry, programing, or a combination thereof to support signaling for mobility in connected mode.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

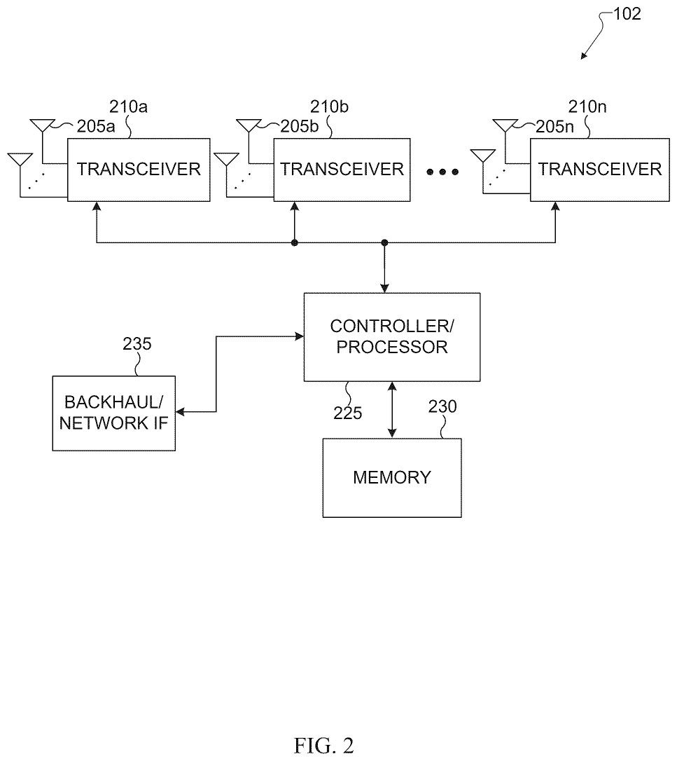

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to signal for mobility in connected mode. Any of a wide variety of other functions could be supported in the gNB 102 by the controller/processor 225.

The controller/processor 225 is also capable of executing programs and other processes resident in the memory 230, such as processes to trigger signaling for mobility in connected mode. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In certain embodiments, a plurality of instructions, such as a blind interference sensing (BIS) algorithm is stored in memory. The plurality of instructions are configured to cause the controller/processor 225 to perform the BIS process and to decode a received signal after subtracting out at least one interfering signal determined by the BIS algorithm.

As described in more detail below, the transmit and receive paths of the gNB 102 (e.g., implemented using the transceivers 210a-210n) support communication with aggregation of frequency division duplexing (FDD) cells and time division duplexing (TDD) cells.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

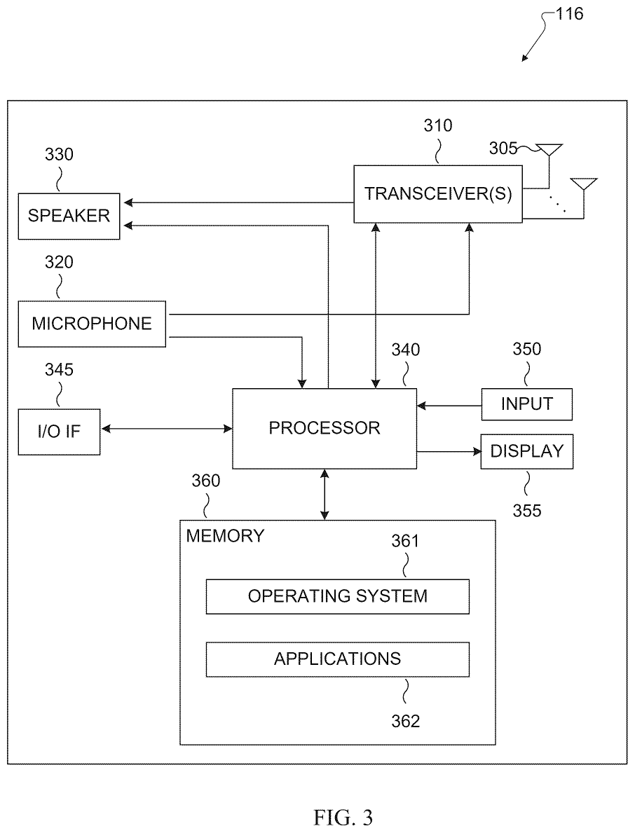

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support signaling for mobility in connected mode as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

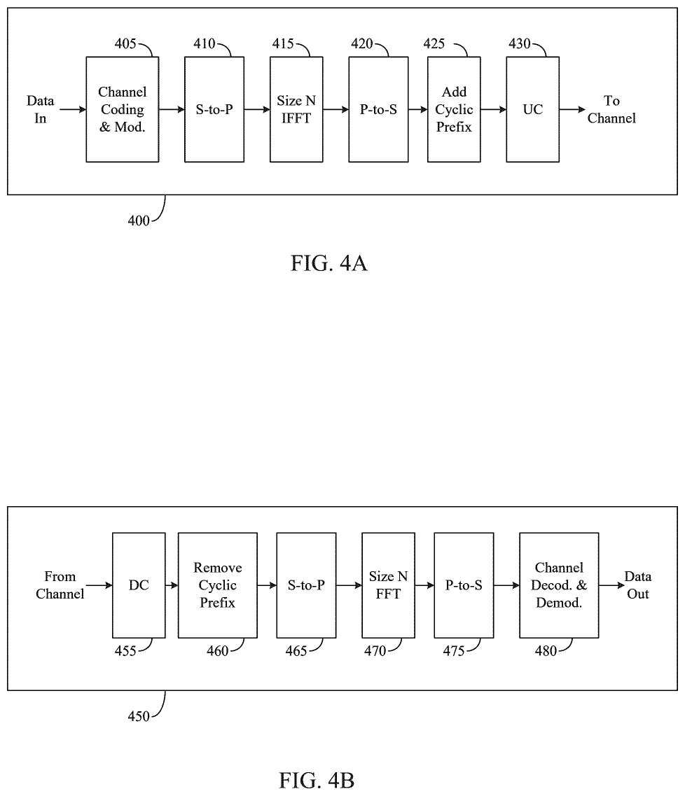

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to support signaling for mobility in connected mode as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

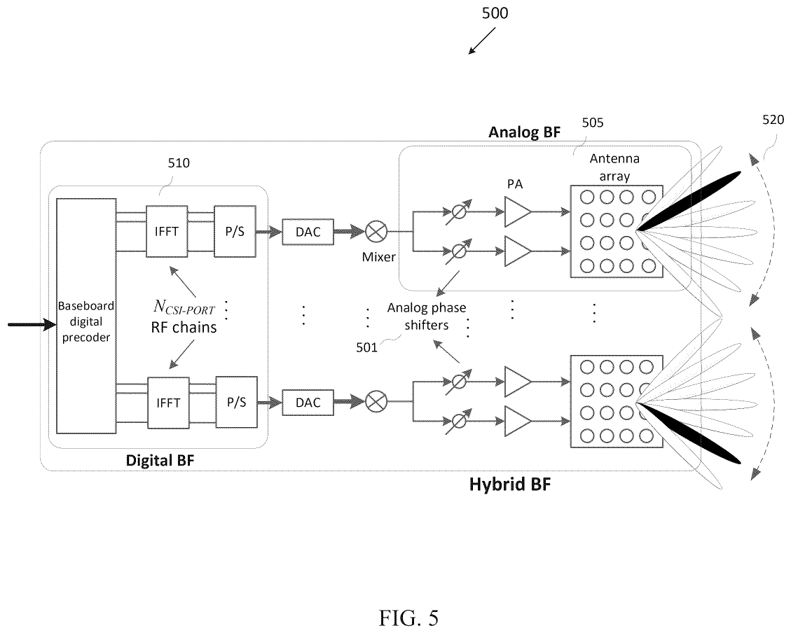

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, an italicized name for a parameter implies that the parameter is provided by higher layers.

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

Information bits, such as downlink control information (DCI) bits or data bits 610, are encoded by encoder 620, rate matched to assigned time/frequency resources by rate matcher 630, and modulated by modulator 640. Subsequently, modulated encoded symbols and demodulation reference signal (DM-RS) or CSI-RS 650 are mapped to REs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

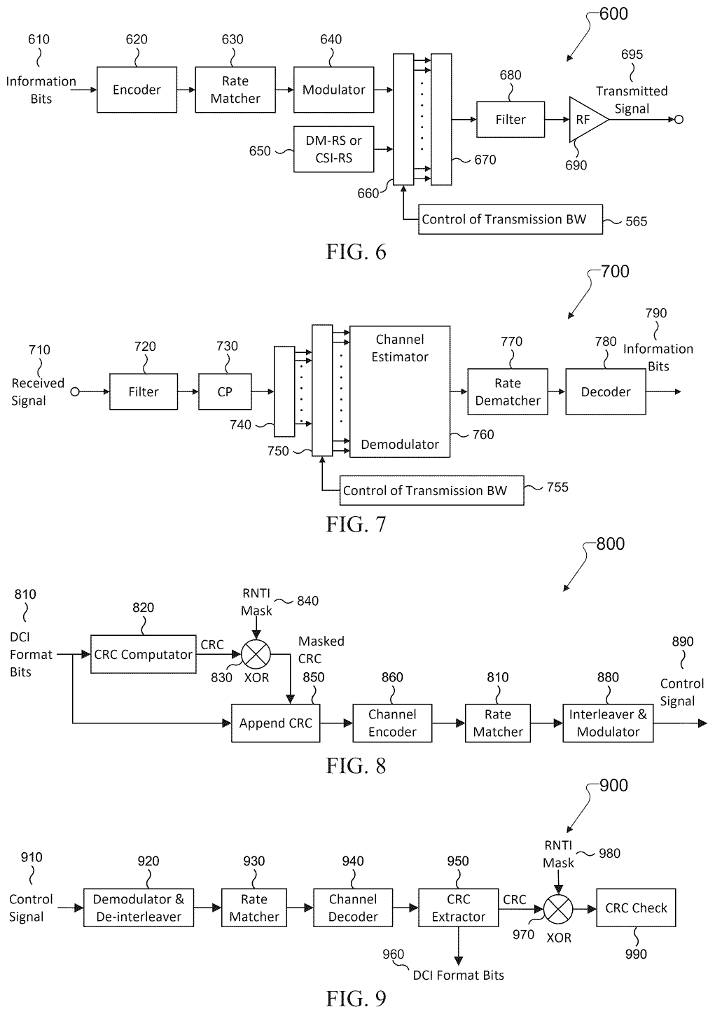

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

A received signal 710 is filtered by filter 720, a CP removal unit removes a CP 730, a filter 740 applies a fast Fourier transform (FFT), RE de-mapping unit 750 de-maps REs selected by bandwidth (BW) selector unit 755, received symbols are demodulated by a channel estimator and a demodulator unit 760, a rate de-matcher 770 restores a rate matching, and a decoder 780 decodes the resulting bits to provide information bits 790.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v18.1.0, “NR; Physical channels and modulation”, and [REF 3].

FIG. 8 illustrates an example encoding structure 800 for PDCCH in a subframe according to embodiments of the present disclosure. For example, encoding structure 800 for PDCCH in a subframe can be implemented in gNB 103 of FIG. 1. This example is for illustration only and other embodiments can be used without departing from the scope of the present disclosure.

A gNB (e.g., the gNB 102) separately encodes and transmits each DCI format in a respective PDCCH. When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 810 is determined using a CRC computation unit 820, and the CRC is masked using an exclusive OR (XOR) operation unit 830 between CRC bits and RNTI bits 840. The XOR operation is defined as XOR (0,0)=0, XOR (0,1)=1, XOR (1,0)=1, XOR (1,1)=0. The masked CRC bits are appended to DCI format information bits using a CRC append unit 850. An encoder 860 performs channel coding, such as polar coding, followed by rate matching to allocated resources by rate matcher 870. Interleaving and modulation units 880 apply interleaving and modulation, such as QPSK, and the output control signal 890 is transmitted.

FIG. 9 illustrates an example decoding structure 900 for PDCCH in a subframe according to embodiments of the present disclosure. For example, decoding structure 900 for PDCCH in a subframe can be implemented by any of the UEs 111-116 of FIG. 1. This example is for illustration only and other embodiments can be used without departing from the scope of the present disclosure.

A received control signal 910 is demodulated and de-interleaved by a demodulator and a de-interleaver 920. A rate matching applied at a gNB transmitter is restored by rate matcher 930, and resulting bits are decoded by decoder 940. After decoding, a CRC extractor 950 extracts CRC bits and provides DCI format information bits 960. The DCI format information bits are de-masked 970 by an XOR operation with a RNTI 980 (when applicable) and a CRC check is performed by unit 990. When the CRC check succeeds (check-sum is zero), the DCI format information bits are regarded to be valid. When the CRC check does not succeed, the DCI format information bits are regarded to be invalid.

DCI can serve several purposes. A DCI format includes information elements (IEs) and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a

PDSCH or a PUSCH for a single UE with RRC connection to a gNB, the RNTI is a cell RNTI (C-RNTI) or another RNTI type such as a modulation and coding scheme-cell radio network temporary identifier (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access RNTI (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH transmissions.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates

$${M}_{s}^{( L )}$$

per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v18.0.0 of [REF 2], or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} if

$$( {n}_{f} \cdot {N}_{slot}^{f r ame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. The UE determines CCEs for monitoring PDCCH according to a search space set based on a search space equation as described in [REF 3].

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in [REF 3] and [REF 4].

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE (e.g., the UE 116) performing measurements and corresponding measurement reporting equally apply when measurements and reporting by the UE are based on synchronization signal/physical broadcast channel (SS/PBCH) block receptions or CSI-RS receptions.

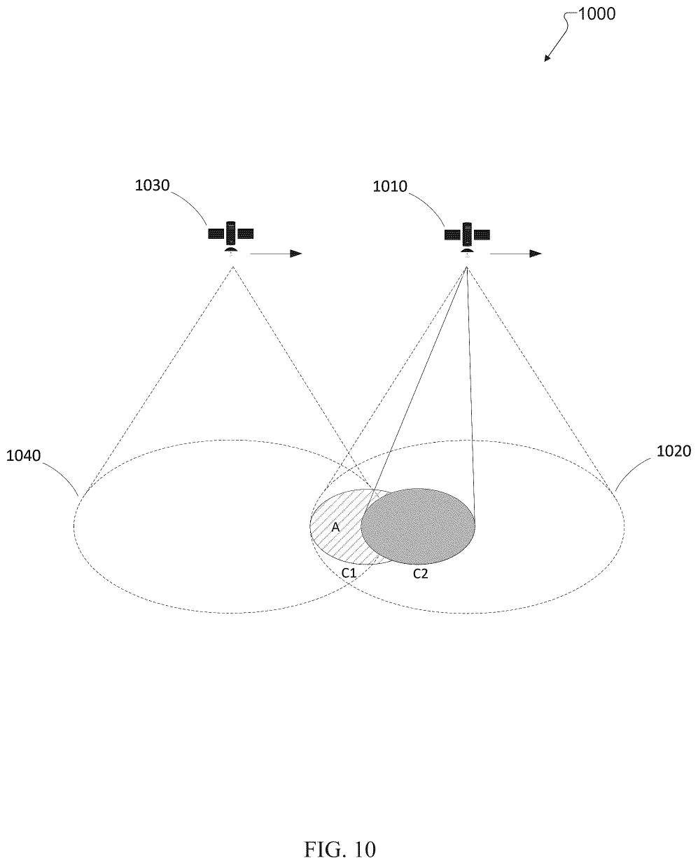

FIG. 10 illustrates an example system 1000 for cell coverage according to embodiments of the present disclosure. For example, system 1000 for cell coverage can serve any of the UEs 111-116 of FIG. 1. This example is for illustration only and other embodiments can be used without departing from the scope of the present disclosure.

As the satellite moves, area A of cell C1 would be outside of the satellite footprint, and a UE (e.g., the UE 116) in area A would handover to a target satellite, or generally to a target gNB. The serving gNB can prepare a handover (HO) from the current serving cell based on measurement reports by the UE. A criterion for detecting the degradation of the quality of receptions at the UE that would trigger the start of the HO to a target cell, such as the variation of the reference signal received power (RSRP) or reference signal received quality (RSRQ) between the cell center and the cell edge as used in TN, or between two areas of the cell may not be appropriate for NTN because the variation of the RSRP or RSRQ would be small due to the large distance between the UE and the satellite, and additionally in NTN measurement errors would be larger. Besides, as the satellite moves, the UE at the cell edge would suddenly be out of coverage although the RSRP or RSRQ measured when the UE is at the cell edge but still in coverage would have a negligible variations respect to the RSRP or RSRQ measured at the cell center.

With reference to FIG. 10, UEs in area A of C1 would handover from source satellite 1010 to target satellite 1030 as the area A would transition from being within the footprint 1020 of the source satellite to the footprint 1040 of the target satellite. Handover of UEs in area A can be a group procedure based on location. As the satellite trajectory is known in advance, UEs located in an area of the satellite footprint can receive the HO command and start the HO procedure. In a subsequent time instance, as the satellite keeps moving, UEs in another area may receive the HO command and start the HO procedure. By allowing group handover based on UE location signaling overhead and UE measurements can be reduced.

With reference to FIG. 10, an example is shown when a satellite uses multiple beams to cover the satellite footprint, and for a time period the satellite may activate one or multiple beams to cover a portion of the satellite footprint. A group handover based on location can be done for UEs that are located within the area covered by a beam, for example in cell C1, or located in part of the area covered by a beam, for example in area A of cell C1, within the satellite footprint of the source satellite. Thus, the group handover can be beam based when the HO command is associated with a beam and UEs located in the area covered by the beam receive the HO command, or the group handover can be sub-beam based if subject to additional conditions.

The group handover based on location may also apply when the satellite provides coverage over the entire footprint using a single beam, although this is not a preferred deployment for satellites. As the satellite moves, UEs in a portion of the satellite footprint would handover to a target satellite. Such deployment scenario may apply for HAPS or similar aerial vehicles, for which the footprint would be a much smaller area respect to the satellite footprint, and the use of a single beam would be more likely.

The group handover procedure based on location may equally apply or can be easily adapted to terrestrial networks. The gNB sends the HO command to UEs located in an area of the cell covered by a beam, and the UEs in that area may start the HO procedure subject to other additional conditions.

Therefore, embodiments of the present disclosure recognize that there is a need to define the signalling to trigger the start of an HO.

Embodiments of the present disclosure further recognize that there is another need to define procedures for HO in NTN based on UE location.

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE performing measurements and corresponding measurement reporting equally apply when measurements and reporting by the UE are based on SS/PBCH block receptions or CSI-RS receptions.

The following descriptions and embodiments directly apply or are adaptable to terrestrial networks (TN) and non-terrestrial networks (NTN), and functionalities of a satellite and/or of a satellite gateway on earth that is connected to the satellite in NTN can be same as the functionalities of a serving gNB in TN, or can be adapted taking also into account that the satellite footprint of a Low Earth Orbit (LEO) satellite moves over time because of the movement of the satellite respect to the earth. For a Geostationary Earth Orbiting (GEO) satellite, the satellite footprint is fixed, similar to a coverage area of a cell by the gNB in TN.

Throughout this disclosure the terms satellite or serving gNB are used interchangeably to refer to any component (or collection of components) configured to provide remote terminals with wireless access to a network. Descriptions directly apply to satellite network architectures with transparent payload and with non-transparent payload, and to any aerial platforms such as unmanned aerial service (UAS) platforms. Descriptions directly apply or can be adapted to terrestrial networks.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area. A beam is defined based on a spatial relation for quasi co-location (QCL) properties of a source reference signal (RS) transmission, such as an SS/PBCH block (SSB) or a CSI-RS, or by a transmission configuration indicator (TCI) state that establishes a QCL relation or spatial relation between a source reference signal, such as an SSB and/or CSI-RS, and a target reference signal such as a DM-RS. The TCI state and/or the spatial relation reference RS can determine a spatial Rx filter for receptions by the UE, or a spatial Tx filter for transmissions from the UE. The TCI state and/or the spatial relation reference RS can determine a spatial Tx filter for transmissions from the gNB, or a spatial Rx filter for receptions by the gNB.

The following descriptions and examples apply to any type of handover from a source gNB to a target gNB in terrestrial networks and non-terrestrial networks, including HO, CHO and random access channel (RACH)-less HO. Throughout this disclosure terms handover or HO are interchangeably used to refer to any type of handover.

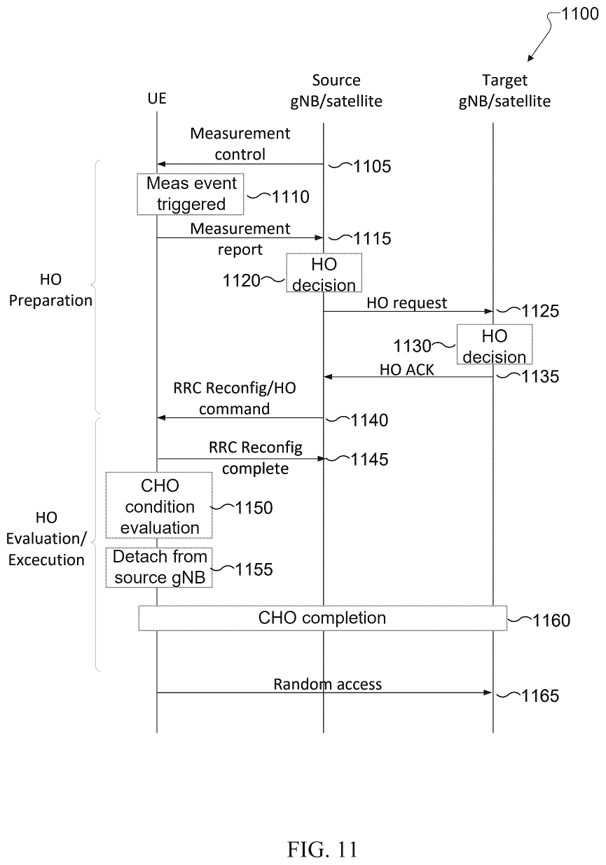

FIG. 11 illustrates a flowchart of an example procedure 1100 for CHO according to embodiments of the present disclosure. For example, procedure 1100 can be performed by the UE 116, the gNB 102 and/or network 130, and the gNB 103 and/or network 130 in the wireless network 100 of FIG. 1. This example is for illustration only and other embodiments can be used without departing from the scope of the present disclosure.

The procedure begins in 1105 with a triggered measurement event, wherein a source gNB/satellite transmits measurement control information to a UE. In 1110, the UE performs a measurement that is event triggered. In 1115, the UE transmits a measurement report to the source gNB/satellite. In 1120, the source gNB/satellite determines a HO decision. In 1125, the source gNB/satellite transmits a HO request to a target gNB/satellite. In 1130, the target gNB/satellite determines a HO decision. In 1135, the target gNB/satellite transmits a HO acknowledgement (ACK) to the source gNB/satellite. In 1140, the source gNB/satellite transmits a RRC Reconfig/HO command to the UE. In 1145 the UE transmits a RRC Reconfig complete to the source gNB/satellite. In 1150, the UE performs a CHO condition evaluation. In 1155, the UE detaches from the source gNB/satellite. In 1160, the UE, the source gNB/satellite, and the target gNB/satellite complete the CHO. In 1165, the UE transmits to the target gNB/satellite random access.

A UE in RRC_CONNECTED state can be provided by higher layers a configuration for intra-frequency or inter-frequency measurements of neighbor cells. Based on measurement reports from the UE to a gNB, the gNB can prepare a handover (HO) from the current serving cell, i.e., source cell, to a target cell and trigger the HO execution by transmitting a HO command in an RRC message (e.g., RRCReconfiguration).

The gNB can also prepare a conditional HO (CHO) with multiple candidate cells for the UE to evaluate and transmits CHO configuration in an RRC message (e.g., RRCReconfiguration) to trigger the CHO evaluation. The UE starts evaluating the execution condition(s) upon receiving the CHO configuration and stops evaluating the execution condition(s) once a handover is executed. An execution condition may include one or two trigger condition(s). For the evaluation of a CHO execution condition of a single candidate cell at most two different trigger quantities can be configured simultaneously. For example, RSRP and RSRQ, or RSRP and signal-to-interference-plus-noise ratio (SINR), etc.

FIG. 11 shows the steps of a CHO procedure that uses measurements for triggering (A3 event), and the A3 event is triggered when the signal strength of a target cell is larger than a dB margin than the signal strength of the source serving cell for a time period. 1) The source gNB configures the UE measurement procedures and the UE reports according to the measurement configuration. 2) The source gNB decides to use CHO. 3) The source gNB requests CHO for one or more candidate cells belonging to one or more candidate gNBs. A CHO request message is sent for each candidate cell. 4) Admission Control may be performed by the target gNB. 5) The candidate gNB(s) sends CHO response (HO REQUEST ACKNOWLEDGE) including configuration of CHO candidate cell(s) to the source gNB. The CHO response message is sent for each candidate cell. 6) The source gNB sends an RRCReconfiguration message to the UE, containing the configuration of CHO candidate cell(s) and CHO execution condition(s). 7) The UE sends an RRCReconfigurationComplete message to the source gNB. 8) The UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronizes to that candidate cell and completes the RRC handover procedure by sending RRCReconfigurationComplete message to the target gNB. The UE releases stored CHO configurations after successful completion of RRC handover procedure.

Due to the large propagation distance between a UE and a gNB in NTN, HO delay and interruption caused by message exchanges between the UE and the gNB can be large. Due to the large size of an NTN cell, a large number of UEs may need to perform HO almost at the same time for quasi-fixed cell. In order to reduce the HO delay and HO overhead, RACH-less HO, i.e., HO without RACH, can be used. In RACH-less HO, the UE performs DL and UL synchronization autonomously based on configurations in the RACH-less HO command. Then, the UE sends an initial UL transmission to inform a target gNB of a UE presence in the target cell, the target gNB sends a confirmation to the UE, and the RACH-less HO is declared to be successfully completed. The RACH-less HO procedure can also be applied to reduce the HO delay and HO overhead in terrestrial networks.

An NTN is a network using RF resources on board satellites or unmanned aerial service (UAS) platforms. The NTN includes satellites that can be GEO satellites served by one or several satellite-gateways deployed across the satellites targeted coverage, or LEO satellites served successively by one or several satellite-gateways at a time, a radio link between a satellite-gateway and the satellite or UAS platform, and a radio link between the UE and the satellite or UAS platform. A satellite or UAS platform may implement either a transparent payload, wherein the NTN payload transparently forwards the radio protocol received from the UE (via the service link) to the NTN Gateway (via the feeder link) and vice-versa, or a regenerative payload with onboard processing. An NTN gateway may serve multiple NTN payloads, and an NTN payload may be served by multiple NTN gateways. The satellite or UAS platform typically generates several beams over a service area or satellite footprint bounded by its field of view. The satellite footprint depends on the onboard antenna diagram and elevation angle. The footprint of a beam or a beam spot can have an elliptic shape and be regarded for some aspects as a cell in terrestrial networks.

Beams over a satellite footprint can be generated by using multi-feed reflector antennas or phased-array antennas at the satellite. GEO satellites are usually equipped with multi-feed reflector antennas, while phased-array antennas are used for LEO satellites because of their wide-angle coverage capabilities. In order to suppress interference, different frequency bands and orthogonal polarizations may be used for the different beams, and reuse of the frequency bands would be among sufficiently isolated beams to guarantee sufficient system capacity. For LEO satellites, the coverage area and the propagation channel characteristics change due to the fast movement of the satellites, requiring a fast adaptation of resource allocation during connected and non-connected modes for a UE. Because of the large satellite footprint, traffic can be unequally distributed within the satellite footprint, including areas with high traffic and usually large areas with sparse or no traffic. In addition, limited payload power and feeder link bandwidth may limit the number of satellite beams that can be active simultaneously with a nominal equivalent isotropic radiated power (EIRP) density per beam. Such constraints demand solutions that minimize energy consumption and avoid, or at least minimize, interference between transmissions or receptions in different beams. Thus, it is necessary to flexibly control resources in the multiple beams of a satellite footprint in time, frequency, space or power domain to optimize performance while maintaining coverage.

Similar issues and need for solutions described herein for NTN directly apply to TN, wherein a serving gNB (e.g., the BS 102) can operate with several beams for transmissions and receptions within a cell. The cell, differently than the NTN case or any aerial platform, does not move as the serving gNB is in a fixed position, however the traffic situation changes over time with some UEs requiring access and/or service and some other UEs transitioning from RRC_CONNECTED state to RRC_IDLE or RRC_INACTIVE state. Mobility of UEs or other types of terminals changes the traffic within the cell, thus there is a need to adapt the network operation within cell in order to provide the required services while optimizing network energy savings and UE power consumption. Thus, it is necessary to flexibly control resources within the cell in time, frequency, space or power domain to optimize performance, minimize energy consumption for the network (e.g., the network 130) and the UEs while maintaining coverage.

One technique that can be used for controlling a transmission power of a satellite or of a network unit, transmissions and receptions for a time interval, antenna direction, or frequency band, is often referred to as beam hopping to generally indicate adaptation of a beam over a coverage area, including switching on and off beams over time over different areas or varying the transmit power of beams. Beam hopping can provide an efficient allocation of resources based on dynamic traffic needs within a satellite footprint.

Within the satellite footprint there can be a number of cells or spots, and each beam provided by a given NTN-payload can cover one cell or spot. The satellite uses a number of beams over the satellite footprint to serve users in corresponding number of cells for a given time period. Within the satellite footprint there can be tens of beams, and corresponding cells, and the cells can use different bandwidth parts (BWPs), or at least adjacent cells use different BWP. For example, the satellite footprint can include a number N of cells or spots, and the satellite at any given time activates a number M of beams, with M<N, or activates N beams. When the traffic over the satellite footprint is expected to be approximately equally distributed, or when there is a need to provide a same level of coverage in the satellite footprint, the satellite can use beams of approximately same beam width and transmit with approximately same power on each beam over the satellite footprint. When there is no traffic in a given area of the satellite footprint served by a beam, the satellite can switch off the beam. The satellite can use a beam with a first beam width, and over time, adapt the beam width to provide coverage over a larger area with a second beam width.

For example, a satellite can use a beam width to transmit in a certain direction, and adapt a transmit power to provide coverage over a smaller area with a transmit power P1 or over a larger area with a transmit power P2 that is larger than P1.

For example, a satellite can adapt a beam width to provide coverage over a smaller or larger area, and correspondingly adapt also the transmit power by transmitting with a smaller transmit power when using the beam with the smaller beam width and transmitting with a larger transmit power when using the beam with the larger beam width.

For example, a satellite while transmitting at a maximum power can adapt a beam width of a beam without changing the direction of the beam to provide coverage over a largest area within the satellite footprint, and/or can steer the beam in a different direction.

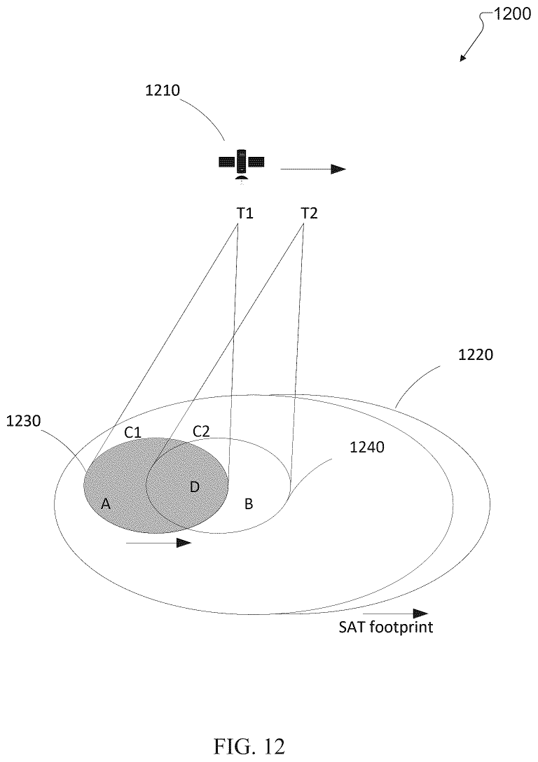

FIG. 12 illustrates an example system 1200 for cell coverage according to embodiments of the present disclosure. For example, system 1200 for cell coverage can serve any of the UEs 111-116 of FIG. 1. This example is for illustration only and other embodiments can be used without departing from the scope of the present disclosure.

For LEO satellites, or generally for satellites and aerial platform that are not geostationary, as illustrated in FIG. 12, the coverage area provided by a beam within a satellite footprint (1220), changes overtime from C1 (1230) at time T1 to C2 (1240) at time T2 due to the relative movement of the satellite or aerial platform (1210) and the earth. Parts of C1 would transition from in-coverage to out-of-coverage as the satellite moves away, and the transition from in-coverage to out-of-coverage happens on a time scale that depends on the satellite speed.

While moving from T1 to T2, the satellite can keep active a beam with a same beam width and a same direction, and the coverage area changes from C1 to C2. A UE that is in the area A of C1, at time T2 would be out of coverage, and the satellite would provide coverage by activating another beam or by increasing the power of the current beam or by changing the beam width and/or the direction of the current beam. In C1, the UE may expect to receive SS/PBCH blocks or system information or CSI-RS indicated by higher layers, or to transmit physical random access channel (PRACH) or sounding reference signal (SRS) using resources indicated by higher layers, and when the quality of receptions at the UE and/or at the satellite degrades below a certain threshold, the satellite would provide coverage by adapting the power and/or the beam width and/or the direction of the current beam, or by activating a new beam. Threshold values can be different when determining the quality of receptions at the UE or at the satellite, and procedures to initiate the beam adaptation can be different depending on the UE location and on whether the UE is in RRC_IDLE or RRC_INACTIVE state or in RRC_CONNECTED state.

As the satellite moves, area A of cell C1 would be outside of the satellite footprint, and a UE in area A would handover to a target satellite, or generally to a target gNB (e.g., the BS 103).

The serving gNB can prepare a HO from the current serving cell based on measurement reports by the UE. A criterion for detecting the degradation of the quality of receptions at the UE that would trigger the start of the HO to a target cell, such as the variation of the RSRP or RSRQ between the cell center and the cell edge as used in TN, or between two areas of the cell may not be appropriate for NTN because the variation of the RSRP or RSRQ would be small due to the large distance between the UE and the satellite, and additionally in NTN measurement errors would be larger. Besides, as the satellite moves, the UE at the cell edge would suddenly be out of coverage although the RSRP or RSRQ measured when the UE is at the cell edge but still in coverage would have a negligible variations respect to the RSRP or RSRQ measured at the cell center.

As illustrated in FIG. 10, UEs in area A of C1 would handover from source satellite 1010 to target satellite 1030 as the area A would transition from being within the footprint 1020 of the source satellite to the footprint 1040 of the target satellite. Handover of UEs in area A can be a group procedure based on location. As the satellite trajectory is known in advance, UEs located in an area of the satellite footprint can receive the HO command and start the HO procedure. In a subsequent time instance, as the satellite keeps moving, UEs in another area may receive the HO command and start the HO procedure. By allowing group handover based on UE location signaling overhead and UE measurements can be reduced.

With reference to FIG. 10, an example is shown when a satellite uses multiple beams to cover the satellite footprint, and for a time period the satellite may activate one or multiple beams to cover a portion of the satellite footprint. A group handover based on location can be done for UEs that are located within the area covered by a beam, for example in cell C1, or located in part of the area covered by a beam, for example in area A of cell C1, within the satellite footprint of the source satellite. Thus, the group handover can be beam based when the HO command is associated with a beam and UEs located in the area covered by the beam receive the HO command, or the group handover can be sub-beam based if subject to additional conditions.

The group handover based on location may also apply when the satellite provides coverage over the entire footprint using a single beam, although this is not a preferred deployment for satellites. As the satellite moves, UEs in a portion of the satellite footprint would handover to a target satellite. Such deployment scenario may apply for HAPS or similar aerial vehicles, for which the footprint would be a much smaller area respect to the satellite footprint, and the use of a single beam would be more likely.

The group handover procedure based on location may equally apply or can be easily adapted to terrestrial networks. The gNB sends the HO command to UEs located in an area of the cell covered by a beam, and the UEs in that area may start the HO procedure subject to other additional conditions.

Therefore, embodiments of the present disclosure further recognize that there is a need to define the signalling to trigger the start of an HO.

Embodiments of the present disclosure further recognize that There is another need to define procedures for HO in NTN based on UE location.

Embodiments of the present disclosure further recognize that There is also another need to define procedures for HO in NTN based on UE location.

A coverage area provided by a beam, also referred as a cell, a number of beams within a satellite footprint can vary substantially, and there can be tens or hundreds of beams within a satellite footprint, of which none or some or all can be active at the same time. Beams within the satellite footprint can use same or different BWPs or frequency ranges, transmit powers, beam widths, beam directions. Moreover, an area can be served only by a downlink beam for a given time period, and single or multiple beams in the uplink can be active only for a portion of time while the downlink beam is active. In other words, a cell discontinuous transmission (DTX) operation and a cell discontinuous reception (DRX) operation can be implemented flexibly over a cell in time and/or frequency, and differently in cells of the satellite footprint. Other embodiments of a non-terrestrial network shown in FIGS. 12 and 10 could be used without departing from the scope of this disclosure, and could include a terrestrial network.

In a first approach, when a satellite uses multiple beams to cover the satellite footprint, and for a time period the satellite may activate one or multiple beams to cover a portion of the satellite footprint, wherein a beam covers an area of the satellite footprint referred as a cell, a HO from a source gNB to a target gNB for a UE that is located within the cell is based on the UE location and/or the ephemeris data, and the source gNB initiates a HO based on the UE location and/or the ephemeris data and/or measurements based on the quality of received signals, e.g. RSRP or RSRQ, and the HO is cell-based.

In a first example, the HO is cell-based. The source gNB prepares a HO for UEs located in the cell covered by the beam and sends a HO command to UEs in the cell. The source gNB decides to use HO based on the location of the cell and the trajectory of the satellite. From ephemeris data, the source gNB determines the time when to trigger a HO for UEs in the cell. The source gNB may additionally communicate with the target gNB, send a HO request message and wait until reception of an acknowledgment message from the target gNB before sending a reconfiguration message to the UEs in the cell. The target gNB sends a cell-specific reconfiguration message over the source cell. UEs in the source cell send a message to the source gNB to notify that the HO is complete. Then the UEs start communicating with the target gNB.

The HO procedure can include the following steps:
1) The source gNB decides to use HO for UEs in a source cell based on ephemeris data.
2) The source gNB sends a HO request message to a target gNB.
3) Admission Control may be performed by the target gNB.
4) The target gNB sends a HO response (HO REQUEST ACKNOWLEDGE) including configuration of HO target cell to the source gNB.
5) The source gNB sends an RRCReconfiguration message over the source cell to UEs, containing the configuration of HO target cell.

In a second example, the CHO is cell-based. The source gNB prepares a HO for UEs located in the cell covered by the beam and sends a HO command to UEs in the cell. The source gNB decides to use CHO based on the location of the cell and the trajectory of the satellite. From ephemeris data, the source gNB determines the time when to trigger a CHO for UEs in the cell. The source gNB may additionally communicate with candidate target gNBs, send a CHO request message to each candidate target gNB and wait until reception of an acknowledgment message from each target gNB before sending a reconfiguration message to the UEs in the cell. The target gNB sends a cell-specific reconfiguration message over the source cell. UEs in the source cell send a message to the source gNB to notify that the HO is complete. Then the UEs start communicating with the target gNB.

The CHO procedure can include the following steps:
1) The source gNB decides to use HO for UEs in a source cell based on ephemeris data.
2) The source gNB sends a HO request message for one or more candidate cells belonging to one or more candidate gNBs.
3) Admission Control may be performed by the one or more candidate gNBs.
4) The candidate gNBs CHO response (HO REQUEST ACKNOWLEDGE) including configuration of CHO candidate cell(s) to the source gNB. The CHO response message is sent for each candidate cell.
5) The source gNB sends an RRCReconfiguration message over the source cell to the UEs, containing the configuration of CHO candidate cell(s) and CHO execution condition(s).
6) The UE sends an RRCReconfigurationComplete message to the source gNB.

In a third example, the RACH-less HO is cell-based. The source gNB prepares a RACH-less HO for UEs located in the cell covered by the beam and sends a RACH-less HO command to UEs in the cell. In RACH-less HO, the UE (e.g., the UE 116) performs DL and UL synchronization autonomously based on configurations in the RACH-less HO command. Then, the UE sends an initial UL transmission to inform a target gNB of a UE presence in the target cell, the target gNB sends a confirmation to the UE, and the RACH-less HO is declared to be successfully completed.

The following examples apply to any type of handover, including HO, CHO and RACH-less HO as described herein.

In one example, for a UE located in cell covered by a beam, a source gNB initiates a HO based on time. The source gNB acquires information of the time interval that a cell would be in coverage of the source gNB using satellite ephemeris data and beam information. The source gNB also acquires information of the time instance when the cell would be in coverage by the target satellite based on the ephemeris data of the source and target satellite, and/or based on a message received by the target gNB that includes beam information of the target satellite. As the trajectories of source and target satellites are known, the time when the source cell will be in coverage for the target gNB can be determined by the source gNB based ephemeris data.

In one example, the source gNB configures UEs in the source cell to report the location. Based on the UE location, then the source gNB determines the time when the source cell will be in coverage for the target gNB can be determined by the source gNB based ephemeris data.

In one example, the source gNB configures UEs in the source cell to report RSRP or RSRQ. Based on the reported RSRP or RSRQ, then the source gNB determines the time when to send a HO command to the UEs in the cell.

In a second approach, when a satellite uses multiple beams to cover the satellite footprint, and for a time period the satellite may activate one or multiple beams to cover a portion of the satellite footprint, wherein a beam covers an area of the satellite footprint referred as a cell, a HO from a source gNB to a target gNB for a UE that is located within the cell is based on the UE location and/or the ephemeris and/or measurements based on the quality of received signals, e.g. RSRP or RSRQ, and the HO is triggered individually for each UE that is located in the source cell.

Thus, the source gNB prepares the HO for a UE located in the cell covered by the beam and sends a HO command to the UE. The source gNB decides to use HO based on the location of the cell and the trajectory of the satellite. From ephemeris data, the source gNB determines the time when to trigger a HO for the UEs in the cell. The source gNB may additionally communicate with the target gNB, send a HO request message and wait until reception of an acknowledgment message from the target gNB before sending a reconfiguration message to the UE in the cell. The target gNB sends a cell-specific reconfiguration message over the source cell. The UE in the source cell send a message to the source gNB to notify that the HO is complete. Then the UEs start communicating with the target gNB.

In one example, for a UE located in a cell covered by a beam, a source gNB initiates a HO based on time. The source gNB acquires information of the time interval that the UE would be in coverage of the source gNB using satellite ephemeris data and beam information. The source gNB also acquires information of the time instance when the UE would be in coverage by the target satellite based on the ephemeris data of the source and target satellite, and/or based on a message received by the target gNB that includes beam information of the target satellite. As the trajectories of source and target satellites are known, the time when the UE in the source cell will be in coverage for the target gNB can be determined by the source gNB based ephemeris data.

In one example, the source gNB configures the UE in the source cell to report the location. Based on the UE location, then the source gNB determines the time when the UE in the source cell will be in coverage for the target gNB can be determined by the source gNB based ephemeris data.

In one example, the source gNB configures the UE in the source cell to report RSRP or RSRQ. Based on the reported RSRP or RSRQ, then the source gNB determines the time when to send a HO command to the UE.

In a third approach, when a satellite uses multiple beams to cover the satellite footprint, and for a time period the satellite may activate one or multiple beams to cover a portion of the satellite footprint, wherein a beam covers an area of the satellite footprint referred as a cell, a HO from a source gNB to a target gNB for a UE that is located within the cell is based on the UE location and/or the ephemeris and/or measurements based on the quality of received signals, e.g. RSRP or RSRQ, and the HO is triggered for a set of UEs that are located in a portion of the source cell, for example for UEs in area A of cell C1 in FIG. 10. The UEs in area A would be identified by the source gNB based on the UE location.

Thresholds for HO. As a first step of a HO procedure the source gNB configures the UE measurement procedures and the UE reports measurements information according to the measurement configuration. The source gNB can configure a first threshold rsrp-ThresholdHOSource-ntn and the UE reports a measurement if above the threshold, and the measurements are based on receptions from the source gNB. In later steps of the HO procedure, the source gNB can also configure the UE with a second threshold rsrp-ThresholdHOTarget-ntn and the UE reports a measurement if above the threshold, and the measurements are based on receptions from the target gNB.

When a satellite moves from a first position at time T1 to a second position at time T2, wherein the satellite uses a beam to provide coverage for a UE that is located within the area A of C1 of FIG. 12, at time T2 would be out of coverage of the beam, and the satellite would provide coverage to the UE by activating another beam or by adapting the current beam. When the UE approaches the cell edge area of the coverage area of the beam, the transition from in coverage to out of coverage may happen fast and the UE needs to initiate a procedure for beam failure recovery (BFR) or generally a procedure for beam change early enough to be able to start using a new beam for transmissions and receptions without an interruption of transmissions or receptions. Monitoring a radio link quality for beam failure detection may not be sufficient because the radio link quality may substantially degrade. The UE can monitor a parameter associated with the distance between the UE and the satellite. For example, the UE can monitor a UE-gNB round trip time (RTT) and, based on a value of the UE-gNB RTT or on a difference between two UE-gNB RTT values estimated at two time instances, the UE initiates a beam change.

Therefore, embodiments of the present disclosure further recognize that there is a need for a UE to determine when to initiates a beam change or a BFR procedure based on measurements of a time delay associated with a distance between the UE and the gNB/satellite.

Embodiments of the present disclosure further recognize that there is another need for a UE to determine a new beam for transmissions and receptions after a beam change is triggered based on a time delay information.

Embodiments of the present disclosure further recognize that there is also another need for a UE to report an information associated with a measurement of a time delay, to the gNB.

For LEO satellites, or generally for satellites and aerial platform that are not geostationary, as illustrated in FIG. 12, the coverage area provided by a beam within a satellite footprint (1220), changes overtime from C1 (1230) at time T1 to C2 (1240) at time T2 due to the relative movement of the satellite or aerial platform (1210) and the earth. Parts of C1 would transition from in-coverage to out-of-coverage as the satellite moves away, and the transition from in-coverage to out-of-coverage happens on a time scale that depends on the satellite speed.

While the satellite moves from T1 to T2 and keeps active a beam with a same beam width and a same direction, the coverage area changes from C1 to C2. A UE that is in the area A of C1, at time T2 would be out of coverage, and the satellite would provide coverage by activating another beam or by increasing the power of the current beam or by changing the beam width and/or the direction of the current beam. In C1, the UE may expect to receive SS/PBCH blocks or system information or CSI-RS indicated by higher layers, or to transmit PRACH or SRS using resources indicated by higher layers, and when the quality of receptions at the UE and/or at the satellite degrades below a certain threshold, the satellite would provide coverage by adapting the power and/or the beam width and/or the direction of the current beam, or by activating a new beam. Threshold values can be different when determining the quality of receptions at the UE or at the satellite, and procedures to initiate the beam adaptation can be different depending on the UE location and on whether the UE is in RRC_IDLE or RRC_INACTIVE state or in RRC_CONNECTED state.

As the satellite moves, the area C1 would eventually be outside of the satellite footprint, and the UE would handover to another satellite, or generally to another serving gNB. A criterion for detecting the degradation of the quality of receptions at the UE and/or at the satellite in order to start a handover procedure to another satellite can be different from the one used for changing beam or adapting the current beam within the satellite footprint. For example, thresholds for determining the reception quality at the UE and/or at the satellite can be different for handover to another satellite, or the criterion for initiating the handover can be based on the UE location. Latency needs also to be taken into account as the handover procedure may require additional time respect to the beam change within the satellite footprint.

A coverage area provided by a beam, also referred as a cell, within a satellite footprint can vary substantially, and there can be tens or hundreds of beams within a satellite footprint, of which none or some or all can be active at the same time. Beams within the satellite footprint can use same or different BWPs or frequency ranges, transmit powers, beam widths, beam directions. Moreover, an area can be served only by a downlink beam for a given time period, and single or multiple beams in the uplink can be active only for a portion of time while the downlink beam is active. In other words, a cell DTX operation and a cell DRX operation can be implemented flexibly over a cell in time and/or frequency, and differently in cells within the satellite footprint. Other embodiments of a non-terrestrial network shown in FIG. 12 could be used without departing from the scope of this disclosure, and could include a terrestrial network.

When a satellite moves from a first position at time T1 to a second position at time T2, wherein the satellite uses a beam to provide coverage for a UE that is located within the area A of C1 of FIG. 12, at time T2 would be out of coverage of the beam, and the satellite would provide coverage to the UE by activating another beam or by adapting the current beam. When the UE approaches the cell edge area of the coverage area of the beam, the transition from in coverage to out of coverage may happen fast and the UE needs to initiate a procedure for beam failure recovery (BFR) or generally a procedure for beam change early enough to be able to start using a new beam for transmissions and receptions without an interruption of transmissions or receptions. Monitoring a radio link quality for beam failure detection may not be sufficient because the radio link quality may substantially degrade. The UE can monitor a parameter associated with the distance between the UE and the satellite. For example, the UE can monitor a UE-gNB round trip time (RTT), and based on a value of the UE-gNB RTT or on a difference between two UE-gNB RTT values estimated at two time instances the UE initiates a beam change.

Therefore, embodiments of the present disclosure further recognize that there is a need for a UE to determine when to initiates a beam change or a BFR procedure based on measurements of a time delay associated with a distance between the UE and the gNB/satellite.

Embodiments of the present disclosure further recognize that there is another need for a UE to determine a new beam for transmissions and receptions after a beam change is triggered based on a time delay information.

Embodiments of the present disclosure further recognize that there is also another need for a UE to report an information associated with a measurement of a time delay, to the gNB.

Throughout this disclosure, the term BFR is used to indicate a procedure including one or more steps for a UE to change a beam for transmissions and receptions to/from one or more satellite or serving gNB, or to/from one or more other UE.

The following descriptions and embodiments for a UE-gNB RTT delay directly apply and/or are easily adaptable to a timing advance (TA). An example of a determination of a TA is described in [REF 1] v18.1.0 clause 4.3.1 and [REF 3] v18.1.0 clause 4.2.

A BFR procedure at a UE can include some or all of the following steps: beam failure detection, new candidate beam identification, BFR request transmission and monitoring of the response from a serving node to the BFR request. The UE can be provided parameters via RRC signaling in RadioLinkMonitoringConfig, RadioLinkMonitoringRS, BeamFailureRecoveryConfig, PRACH-ResourceDedicatedBFR, BFR-SSB-Resource, or BFR-CSIRS-Resource, as described in TS 38.331 v18.1.0 for a TN, that are specific for the BFR procedure in NTN. For example, if the UE acquires SIB19 that includes NTN-specific parameters, the UE can be configured some or all of the NTN-specific BFR parameters herein.

A first step of a BFR procedure at a UE is beam failure detection by the UE.

Beam failure detection can be based on a rsrp-ThresholdBFR-ntn threshold provided via RRC signaling by the satellite or serving gNB. The UE can periodically monitor a radio link quality based on receptions of SS/PBCH blocks or CSI-RSs resource configurations indicated by a satellite or serving gNB. The UE determines RSRP measurements based on SS/PBCH blocks or CSI-RSs that are transmitted periodically by the satellite or serving gNB using a current beam. When a measured RSRP based on receptions of SS/PBCH blocks or CSI-RSs is below a threshold, for example below rsrp-ThresholdBFR-ntn threshold, if provided, the UE sends a request to the satellite or the serving gNB in order for the UE to be provided a beam indication and to start a BFR procedure using the indicated beam as a candidate beam. RSRP measurements may not substantially differ within the coverage area of a beam. Thus, there is a need to use, alternatively or additionally to RSRP measurements, other measurements and parameters to determine a beam failure detection.

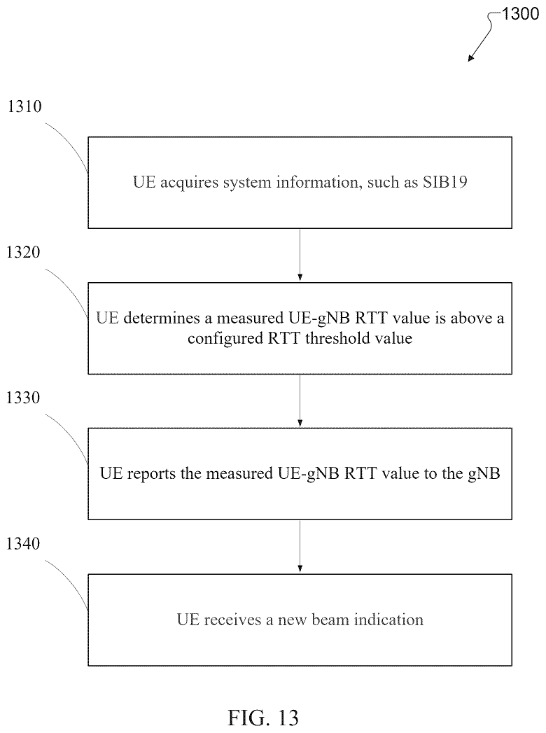

FIG. 13 illustrates a flowchart of an example UE procedure 1300 for reporting a measured UE-gNB RTT value and a reception of a new beam indication according to embodiments of the present disclosure. For example, procedure 1300 can be performed by any of the UE1 111-116 of FIG. 1, such as the UE 111. This example is for illustration only and other embodiments can be used without departing from the scope of the present disclosure.

A UE acquires system information, such as SIB19, that provides parameters such as ephemeris data, common timing advance parameters, koffset, validity duration for UL synchronization epoch time, and an RTT threshold value 1310. Based on the parameters, the UE determines a measured UE-gNB RTT value is above a configured RTT threshold value 1320. The UE reports the measured UE-gNB RTT value to the gNB 1330. The UE receives a new beam indication 1340.

In a first approach, the UE determines periodically a measured UE-gNB RTT value, and based on whether the measured UE-gNB RTT value is above an RTT threshold value, the UE may report the measured UE-gNB RTT value to the gNB, or indicate to the gNB that the measured UE-gNB RTT value is above the RTT threshold value, or send a request to the gNB to be provided a beam indication. The RTT threshold value can be (pre-) configured to the UE, for example it can be provided in a SIB19, or broadcasted periodically by the gNB or acquired from the gNB after a UE request. Alternatively or additionally, the RTT threshold value can be indicated by the gNB to the UE via a MAC CE or a DCI format.

With reference to FIG. 13, an example procedure is shown for a reporting of a measured UE-gNB RTT value and a reception of a new beam indication according to the disclosure.

The UE can provide UE-gNB RTT measurements periodically to the gNB based on a configuration, or after receiving a request from the gNB in a DCI format or in a MAC CE. The UE can provide UE-gNB RTT measurements periodically with period Pl to the gNB based on a configuration, and the gNB indicates in a DCI format or in a MAC CE a new periodicity P2.

The UE can also provide UE-gNB RTT measurements after verifying a condition associated with the UE location. For example, the condition can be that the UE is located within an area, and information of the area is (pre-) configured to the UE, or broadcasted periodically by the gNB or acquired from the satellite or serving gNB after a UE request.

In a first example, based on the measured UE-gNB RTT value reported by the UE, the gNB may provide to the UE a new beam indication and the UE starts transmitting and receiving using the new beam, after acquiring time and frequency synchronization. The beam indication can be an SS/PBCH block index or a CSI-RS resource index, and the UE transmits a channel or signal with a spatial setting associated with the new beam. The initial transmission using the spatial setting associated with the new beam can be of a PRACH or PUSCH or physical uplink control channel (PUCCH) or SRS.

In a second example, based on the measured UE-gNB RTT value reported by the UE, the gNB may indicate to the UE to start monitoring for beam failure detection using a field in a DCI format on a PDCCH set to a value “0”, or to a value “1”, or by a PDSCH scheduled by a DCI format included in a PDCCH. The beam indication can be an SS/PBCH block index or a CSI-RS resource index. The UE would monitor/receive SS/PBCH blocks, or CSI-RSs transmitted periodically by the gNB using a current beam to assess if the beam failure trigger condition has been met and, if met, the UE transmits a channel or signal with a spatial setting associated with the new beam. The initial transmission using the spatial setting associated with the new beam can be of a PRACH or PUSCH or PUCCH or SRS.

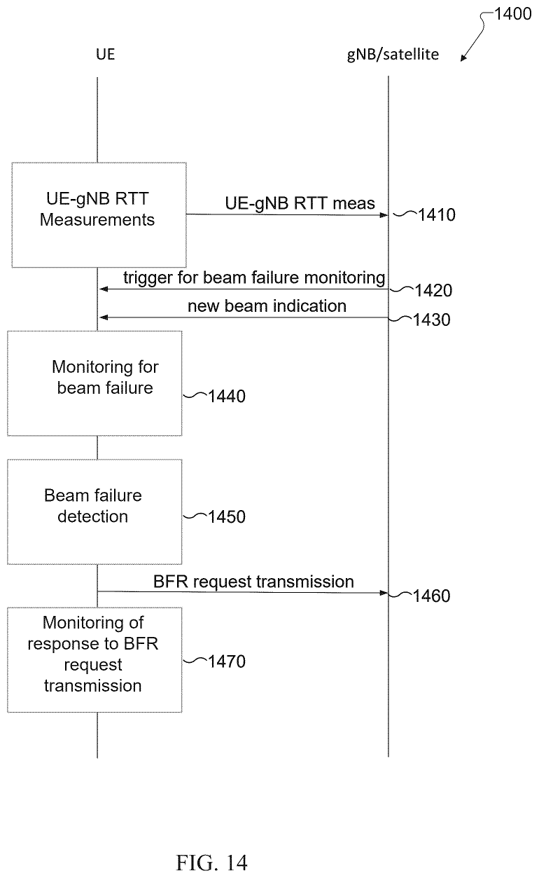

FIG. 14 illustrates a flowchart of an example procedure 1400 for BFR according to embodiments of the present disclosure. For example, procedure 1400 can be performed by the UE 116 and the gNB 102 and/or network 130 in the wireless network 100 of FIG. 1. This example is for illustration only and other embodiments can be used without departing from the scope of the present disclosure.

The procedure begins in 1410, a UE performs UE-gNB RTT measurements and transmits the UE-gNB RTT measurements to a gNB/satellite. In 1420, the gNB/satellite transmits a trigger for beam failure monitoring to the UE. In 1430, the gNB/satellite transmits a new beam indication to the UE. In 1440, the UE monitors for beam failure. In 1450, the UE performs beam failure detection. In 1460, the UE transmits a BFR request transmission to the gNB/satellite. In 1470, the UE monitors for a response to BFR transmission request.

When the initial transmission is for a BFR request, the UE transmits a PRACH and, in response, starts a bfr-ResponseWindow at the start of the first PDCCH occasion after a fixed duration of a number of symbols from the end of the PRACH preamble transmission, wherein bfr-ResponseWindow is the random access response (RAR) response window configured by the satellite or serving gNB for the BFR procedure. The UE monitors PDCCH for detection of a DCI format with CRC scrambled with C-RNTI for response to the BFR request transmission while bfr-ResponseWindow is running.

If the bfr-ResponseWindow expires and the UE has not received a PDCCH providing a DCI format with CRC scrambled with C-RNTI, whether the UE transmits again a PRACH and in response monitors for PDCCH receptions or regards the BFR request procedure unsuccessful and stops beamFailureRecoveryTimer, can be subject to a configuration by gNB.

With reference to FIG. 14, an example of BFR procedure is shown according to the descriptions herein. Based on a UE reporting of a UE-gNB RTT, the UE may receive an indication to start monitoring for beam failure detection using the rsrp-ThresholdBFR-ntn threshold and an indication of a new beam that the UE would use for BFR.

In an alternative to the BFR procedure illustrated in FIG. 14, the UE can perform a beam change procedure from a first beam that is a current beam to a second beam that is a new beam provided by gNB after the UE report a measured UE-gNB RTT value. When the UE receives information for the second beam, the UE transmits a PRACH using a spatial setting associated with the second beam and starts a ResponseWindow at the start of the first PDCCH occasion after a fixed duration of a number of symbols from the end of the PRACH preamble transmission, wherein ResponseWindow is the RAR response window configured by the satellite or serving gNB for the beam change procedure. The UE monitors PDCCH for detection of a DCI format with CRC scrambled with C-RNTI in response to the PRACH transmission while ResponseWindow is running. If the ResponseWindow expires and the UE has not detected a PDCCH providing a DCI format with CRC scrambled with C-RNTI, the UE sends a request to the satellite or serving gNB to trigger a handover procedure. The UE sends the request by transmitting a PRACH with a spatial setting associated with the first beam.

When a UE is configured to perform UE-gNB RTT measurements periodically or after receiving a request from the gNB in a DCI format or in a MAC CE, the UE determines a first value and a second value of a UE-gNB RTT in a first time instance and in a second time instance, respectively, wherein the second time instance is later than the first time instance. If the second value is larger than the first value, or is larger than the first value by a configured delta value provided in a SIB or in a UE-specific higher layer parameter, the UE starts monitoring for beam failure detection using the rsrp-ThresholdBFR-ntn threshold or sends a request to the satellite or serving gNB to be provided a beam indication. The first time instance can be the time when the UE is at a minimum distance from the satellite or serving gNB, and the UE may start monitoring for beam failure detection using the rsrp-ThresholdBFR-ntn threshold, or send a request to the satellite or serving gNB to be provided a beam indication, when the UE is at minimum distance from the satellite, that is when the first and second values are same or, equivalently, the delta value is zero.

When a UE (e.g., the UE 116) is configured to perform UE-gNB RTT measurements periodically and/or after receiving a request from the gNB in a DCI format or in a MAC CE, the UE may receive an indication from the gNB when the UE is at a minimum distance from the satellite/gNB. The indication of minimum distance from the satellite/gNB may trigger the UE to perform UE-gNB RTT measurements, and when a measured UE-gNB RTT value is above a configured RTT threshold value, the UE reports the RTT threshold value to the gNB in a MAC CE or reports an indication of the measured UE-gNB RTT value being above the RTT threshold value in a DCI format or in a MAC CE.

Any of the above variation embodiments can be utilized independently or in combination with at least one other variation embodiment.

The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment, the method comprising:
receiving a signal based on first quasi co-location (QCL) properties for the signal;
determining, based on the signal, a round trip time (RTT) value between transmissions to a base station based on a first spatial filter and receptions from the base station based on the first QCL properties;
determining that the RTT value is greater than a threshold value; and
transmitting, to the base station, the RTT value.

2. The method of claim 1, further comprising transmitting an indication to:
stop receptions based on the first QCL properties; and
start receptions based on second QCL properties.

3. The method of claim 1, further comprising receiving an indication to:
stop receptions based on the first QCL properties; and
start receptions based on second QCL properties.

4. The method of claim 1, wherein:
the RTT value is a first RTT value,
the method further comprises determining a second RTT value prior to the first RTT value, and
the second RTT value is smaller than the first RTT value.

5. The method of claim 1, further comprising:
receiving information for (i) an index of a synchronization signal and primary broadcast channel (SS/PBCH) block or (ii) a resource of a channel state information reference signal (CSI-RS);
receiving the SS/PB CH block or the CSI-RS based on second QCL properties; and
transmitting a channel or signal using a second spatial filter associated with the SS/PBCH block or with the CSI-RS.

6. The method of claim 1, further comprising receiving a system information block (SIB), wherein the SIB provides the threshold value.

7. The method of claim 1, further comprising receiving an indication to transmit the RTT value.

8. A user equipment (UE) comprising:
a transceiver configured to receive a signal based on first quasi co-location (QCL) properties for the signal; and
a processor operably coupled to the transceiver, the processor configured to:
determine, based on the signal, a round trip time (RTT) value between transmissions to a base station based on a first spatial filter and receptions from the base station based on the first QCL properties, and
determine that the RTT value is greater than a threshold value,
wherein the transceiver is further configured to transmit, to the base station, the RTT value.

9. The UE of claim 8, wherein the transceiver is further configured to transmit an indication to:
stop receptions based on the first QCL properties; and
start receptions based on second QCL properties.

10. The UE of claim 8, wherein the transceiver is further configured to receive an indication to:
stop receptions based on the first QCL properties; and
start receptions based on second QCL properties.

11. The UE of claim 8, wherein:
the RTT value is a first RTT value,
the processor is further configured to determine a second RTT value prior to the first RTT value, and
the second RTT value is smaller than the first RTT value. 12 The UE of claim 8, wherein the transceiver is further configured to:
receive information for (i) an index of a synchronization signal and primary broadcast channel (SS/PBCH) block or (ii) a resource of a channel state information reference signal (CSI-RS);
receive the SS/PB CH block or the CSI-RS based on second QCL properties; and
transmit a channel or signal using a second spatial filter associated with the SS/PB CH block or with the CSI-RS.

13. The UE of claim 8, wherein:
the transceiver is further configured to receive a system information block (SIB), and
the SIB provides the threshold value.

14. The UE of claim 8, wherein the transceiver is further configured to receive an indication to transmit the RTT value.

15. A base station comprising a transceiver configured to:
transmit a signal based on first quasi co-location (QCL) properties for the signal to a user equipment (UE);
receive, from the UE, a round trip time (RTT) value between receptions by the base station based on a first spatial filter and transmissions from the base station based on the first QCL properties; and
transmit, to the UE, an indication to:
stop receptions based on the first QCL properties; and
start receptions based on second QCL properties.

16. The base station of claim 15, wherein the transceiver is further configured to receive an indication to:
stop receptions based on the first QCL properties; and
start receptions based on second QCL properties.

17. The base station of claim 15, wherein the transceiver is further configured to:
transmit information for (i) an index of a synchronization signal and primary broadcast channel (SS/PBCH) block or (ii) a resource of a channel state information reference signal (CSI-RS):
transmit the SS/PBCH block or the CSI-RS based on second QCL properties; and
receive a channel or signal using a second spatial filter associated with the SS/PBCH block or with the CSI-RS.

18. The base station of claim 15, wherein:
the transceiver is further configured to transmit a system information block (SIB), and
the SIB provides a threshold value for evaluation of the RTT value.

19. The base station of claim 15, wherein:
the transceiver is further configured to transmit a medium access control (MAC) control element (CE), and
the MAC CE provides a threshold value for evaluation of the RTT value.

20. The base station of claim 15, wherein the transceiver is further configured to transmit an indication to receive the RTT value.
